(19) United States
(12) Patent Application Publication
(10) Pub. No.: US 2015/0074355 A1
(43) Pub. Date: Mar. 12, 2015

(54) EFFICIENT CACHING OF FILE SYSTEM JOURNALS

(71) Applicant: LSI Corporation, San Jose, CA (US)

(72) Inventors: Kishore Kaniyar Sampathkumar, Bangalore (IN); Saugata Das Purkayastha, Bangalore (IN)

(73) Assignee: LSI Corporation, San Jose, CA (US)

(21) Appl. No.: 14/066,938

(22) Filed: Oct. 30, 2013

Related U.S. Application Data
(60) Provisional application No. 61/888,736, filed on Oct. 9, 2013.
(60) Provisional application No. 61/876,953, filed on Sep. 12, 2013.

(51) Int. Cl. G06F 12/08; G06F 12/12

(52) U.S. Cl. CPC G06F 12/0808; G06F 12/123
USPC 711/135

(57) ABSTRACT

An apparatus includes a memory and a controller. The memory may be configured to implement a cache and store meta-data. The cache generally comprises one or more cache windows. Each of the one or more cache windows comprises a plurality of cache-lines configured to store information. Each of the plurality of cache-lines is associated with meta-data indicating one or more of a dirty state, an invalid state, and a partially dirty state. The controller is connected to the memory and may be configured to (i) detect an input/output (I/O) operation directed to a file system recovery log area, (ii) mark a corresponding I/O using a predefined hint value, and (iii) pass the corresponding I/O along with the predefined hint value to a caching layer.

This application relates to U.S. Provisional Application No. 61/888,736, filed Oct. 9, 2013 and U.S. Provisional Application No. 61/876,953, filed Sep. 12, 2013, each of which are hereby incorporated by reference in their entirety.

### FIELD OF THE INVENTION

The invention relates to storage systems generally and, more particularly, to a method and/or apparatus for implementing a system and/or methods for efficient caching of file system journals.

### BACKGROUND

In modern file systems, typical meta-data operations are journal-based. The journal-based meta-data operations are committed to on-disk file system journal entries first, then final updates of the file system meta-data are committed to the disk at a later point in time. The caching characteristics of file system journaling are quite different from (in most cases orthogonal to) cache characteristics implemented in conventional data caches. Because of this, the cache performance for journal I/Os using conventional caching schemes is poor and is affected in a negative way.

It would be desirable to have a system and methods for efficient caching of file system journals.

### SUMMARY

The invention concerns an apparatus including a memory and a controller. The memory may be configured to implement a cache and store meta-data. The cache generally comprises one or more cache windows. Each of the one or more cache windows comprises a plurality of cache-lines configured to store information. Each of the plurality of cache-lines is associated with meta-data indicating one or more of a dirty state, an invalid state, and a partially dirty state. The controller is connected to the memory and may be configured to (i) detect an input/output (I/O) operation directed to a file system recovery log area, (ii) mark a corresponding I/O using a predefined hint value, and (iii) pass the corresponding I/O along with the predefined hint value to a caching layer.

### BRIEF DESCRIPTION OF THE FIGURES

Embodiments of the invention will be apparent from the following detailed description and the appended claims and drawings in which:

FIG. 1 is a diagram illustrating a storage system in accordance with an example embodiment of the invention;

FIG. 2 is a diagram illustrating an example cache memory structure;

FIG. 3 is a diagram illustrating an example of journal cache-line offset tracking;

FIG. 4 is a flow diagram illustrating a process for journal cache management;

FIG. 5 is a diagram illustrating sub-cache-line data structures;

FIGS. 6A-6B are a flow diagram illustrating a caching process using sub-cache-lines;

FIG. 7 is a flow diagram illustrating a process for allocating an extended meta-data structure;

FIG. 8 is a flow diagram illustrating an example read-fill process;

FIG. 9 is a flow diagram illustrating an example cache read process;

FIG. 10 is a flow diagram illustrating an example cache write process;

FIG. 11 is a diagram illustrating a doubly linked list of LRU/MRU chain;

FIG. 12 is a diagram illustrating journal wraparound; and

FIG. 13 is a diagram illustrating a storage system in accordance with another example embodiment of the invention.

### DETAILED DESCRIPTION OF THE EMBODIMENTS

Embodiments of the invention include providing a system and methods for efficient caching of file system journals that may (i) provide global tracking structures suited to managing file system journal caching, (ii) provide sub-cache-line management, (iii) modify cache window replacement and retention policies, (iv) isolate caching characteristics of file system journal I/Os, (v) be used also with database transaction logs, and/or (vi) be used with existing cache devices.

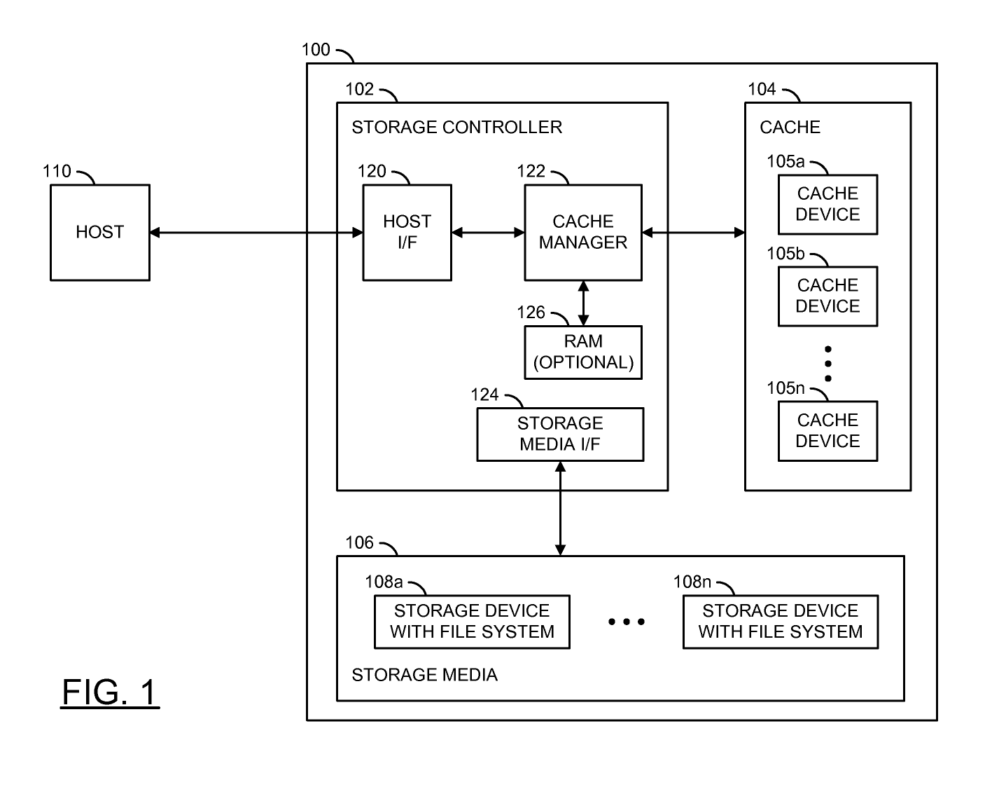

Referring to FIG. 1, a diagram of a system 100 is shown illustrating an example storage system in accordance with an embodiment of the invention. In various embodiments, the system 100 comprises a block (or circuit) 102, a block (or circuit) 104, and a block (or circuit) 106. The block 102 implements a storage controller. The block 104 implements a cache. In various embodiments, the block 104 may be implemented as one or more cache devices 105a-105n. The one or more cache devices 105a-105n are generally administered as a single cache (e.g., by a cache manager of the storage controller 102). The block 106 implements a storage media (e.g., backend drive, virtual drive, etc.). The block 106 may be implemented using various technologies including, but not limited to magnetic (e.g., HDD) and Flash (e.g., NAND) memory. The block 106 may comprise one or more storage devices 108a-108n. Each of the one or more storage devices 108a-108n may include all or a portion of a file system. In various embodiments, the system 100 may be implemented using a non-volatile storage component, such as a universal serial bus (USB) storage component, a CF (compact flash) storage component, an MMC (MultiMediaCard) storage component, an SD (secure digital) storage component, a Memory Stick storage component, and/or an xD-picture card storage component.

In various embodiments, the system 100 is configured to communicate with a host 110 using one or more communications interfaces and/or protocols. According to various embodiments, one or more communications interfaces and/or protocols may comprise one or more of a serial advanced technology attachment (SATA) interface; a serial attached small computer system interface (serial SCSI or SAS interface), a (peripheral component interconnect express (PCIe) interface; a Fibre Channel interface, an Ethernet Interface (such as 10 Gigabit Ethernet), a non-standard version of any of the preceding interfaces, a custom interface, and/or any other type of interface used to interconnect storage and/or communications and/or computing devices. For example, in some embodiments, the storage controller 102 includes a SATA interface and a PCIe interface. The host 110 generally sends data read/write commands (requests) and journal read/write commands (requests) to the system 100 and receives responses from the system 100 via the one or more communications interfaces and/or protocols. The read/write commands generally include logical block addresses (LBAs) associated with the particular data or journal input/output (I/O). The system 100 generally stores information associated with write commands based upon the included LBAS. The system 100 generally retrieves information associated with the LBAs contained in the read commands and transfers the retrieved information to the host 110.

In various embodiments, the block 102 comprises a block (or circuit) 120, a block (or circuit) 122, a block (or circuit) 124, and a block (or circuit) 126. The block 120 implements a host interface (I/F). The block 122 implements a cache manager. The block 124 implements a storage medium interface (I/F). The block 126 implements an optional random access memory (RAM) that may be configured to store images of cache management information (e.g., meta-data) in order to provide faster access. In some embodiments, the block 126 may be omitted. The blocks 104, 122 and 126 (when present) generally implement journal caching data structures and schemes in accordance with embodiments of the invention.

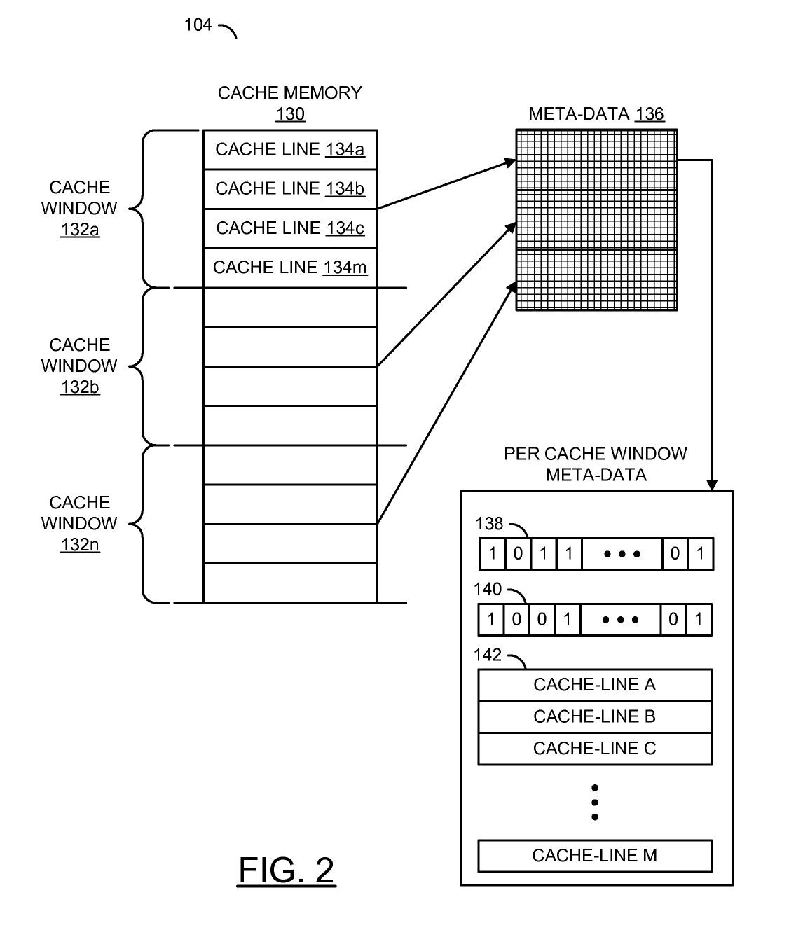

Referring to FIG. 2, a diagram is shown illustrating an example cache memory structure implemented in the block 104 of FIG. 1. Caching implementations have a uniform way of handling all cached information. With reference to file systems, the file system meta-data as well as file system data are handled similarly. In a write back cache mode, cache memory 130 of the block 104 is split into several cache windows 132a-132n. Each of the cache windows 132a-132n are in turn split into several cache-lines 134a-134m. The data that is cached is read or written from the storage media 106 in units of cache-line size. Cache data structures (meta-data) 136 are also defined per cache-line. The meta-data 136 keeps track of whether a particular cache-line is resident in the cache memory 130 and whether the particular cache-line 134a-134m is dirty.

In various embodiments, the meta-data 136 comprises a first (valid) bitmap 138, a second (dirty) bitmap 140, and cache-line information 142. The first bitmap 138 includes a first (valid) flag (or bit) associated with each cache-line 134a-134m. The second bitmap 140 includes a second (dirty) flag (or bit) associated with each cache-line 134a-134m. A state of the first flag indicates whether the corresponding cache-line is valid or invalid. A state of the second flag indicates whether the corresponding cache-line is dirty or clean. In some implementations, the cache-lines within a cache window are not physically contiguous. In that case, the per cache window meta-data 136 stores the information about the cache-lines (e.g. cache line number) which are part of the cache window in the cache-line information 142. In various embodiments, a size of the cache-line information 142 is four bytes per cache-line. The meta-data 136 is stored persistently on the cache device 104 and, when available, also in the block 116 for faster access. For a very large cache memory, typically the cache-line size is large (>=64 KB) in order to reduce the size of the meta-data 136 on the cache device 104 and in the block 116.

Updates of the meta-data 136 are persisted on the cache device 104. Updating of the meta-data 136 is done at the end of each host I/O that modifies the meta-data 136. Updating of the meta-data 136 is also done during a shutdown process. Whenever a cache window 132a-132n is to be flushed (e.g., either during system recovery following a system reboot, or to free up active cache windows as part of a least recently used replacement or maintaining a minimum number of free cache windows in write back mode), the determination of which cache-lines to flush is based on picking all the valid cache-lines that are marked dirty. Usually, the flush is done by a background task. Once the flush is done successfully, the cache-lines are again indicated as being clean (e.g., the dirty bit for the corresponding cache-lines is cleared).

The block 104 generally supports existing caching approaches. For example, the block 104 may be used to implement a set of priority queues (in an example implementation, from 1 to 16, where 1 is the lowest priority and 16 is the highest priority), with more frequently accessed data in higher priority queues, and less frequently accessed data in lower priority queues. A cache window promotion, demotion and replacement scheme may be implemented that is based primarily on LRU (Least Recently Used) tracking. The data corresponding to the cache windows 132a-132n is both read and write intensive. A certain amount of data read/write to a cache window within a specified amount of time (or I/Os) makes the cache window “hot”. Until such time, a “heat index” needs to be tracked (e.g., via virtual cache windows). Once the heat index for a virtual cache window crosses a configured threshold, the virtual cache window is deemed hot, and a real cache window is allocated, indicating that the data is henceforth cached. While the heat index is being tracked, if sequential I/O occurs, the heat index is not incremented for regular data access. This is because caching sequential I/O access of data is counter-productive. Purely sequential I/O access of data is handled as pass-through I/O issued directly to the storage media 106 since these workloads are issued very rarely. These are usually deemed as one time occurrences. The above are processing steps done for non-journal I/O (read or write).

Once a real cache window is allocated, any non-journal I/O (read or write) on a cache-line that is invalid is preceded by a cache read-fill operation. The cache-line is made valid by first reading the data from the corresponding LBAs on the storage medium 106 and writing the same data to the corresponding cache device. Once a cache-line is valid, all writes to the corresponding LBAs are directly written only to the cache device 104 (since the cache is in write back mode), and not written to the storage media 106. Reads on a valid cache-line are fetched from the cache device 104.

When a user I/O request spans across two cache windows, the caching layer breaks the user I/O request into two I/O sub-requests corresponding to the I/O range covered by the respective windows. The caching layer internally tracks the two I/O sub-requests, and on completion of both I/O sub-requests, the original user I/O request is deemed completed. At that time, an I/O completion is signaled for the original user I/O request.

In various embodiments, caching characteristics of file system recovery log I/Os (e.g., journal I/Os, transaction log I/Os, etc.) are isolated (separated) from regular data I/Os. The recovery log entries (e.g., journal entries, transaction log entries, etc.) are organized in a circular fashion. For example, either a circular array, or a circular buffer, may be used depending on the implementation. For journaling, the first cache-line 134 in the first cache window 132 of journal entries is accessed again (specifically, over-written) only after a complete wraparound of the journal. Hence, the set of priority queues used for data caching is inappropriate for maintaining and tracking the journal information. A cache window replacement of journal pages is primarily MRU (Most Recently Used) based, due to the circular fashion in which the journal entries are arranged.

In various embodiments, writes of the journal pages are implemented with a granularity of 4 KB. Hence, the granularity of the cache-lines, and/or, the granularity of cache windows for the journal pages need to be handled differently from the cache windows corresponding to data pages. In general, the granularity of both the cache-line size and cache window size of journal pages is considerably smaller than the cache windows that hold data.

In various embodiments, methods are implemented to handle a difference between journal sizes and data sizes. In some embodiments, the cache-lines 134a-134m of each cache window 132a-132n that are used for journal entries are split into smaller sub-cache-lines. In some embodiments, sizes of both cache-lines and the corresponding cache windows used for journal entries are reduced with respect to cache-lines and cache windows used for data entries. In an example implementation, a data cache window size may be 1 MB with a cache-line size of 64 KB, while for journal entries, either one of two approaches may be used. In one approach, a journal cache window size of 1 MB is split into 16 cache-lines of 64 KB each, and each of the 16 cache-lines is further split into 16 sub-cache-lines of 4 KB each. In the other approach, a journal cache window size of 64 KB is split into 16 cache-lines of 4 KB each. A finer granularity for handling journal write I/Os by the cache device 104 generally improves the journal write performance.

Journals are generally write-only. A read is not issued on journals as long as the file system is mounted. A read is issued only to recover a file system (e.g., during file system mount time). Recovery of a file system generally happens only if the file system is either not un-mounted cleanly, or when a system crash occurs. The conventional scheme used for data windows, where a certain amount of data read/write to a cache window within a specified amount of time (or I/Os) makes the cache window hot, does not work for journal I/Os. Because of the circular nature of journal. I/Os, journal I/Os would not cause a cache window to become hot using the conventional scheme for data windows. A journal write is a purely sequential write. However, the journal write is circular in nature, and wraps around multiple times. Hence, a journal entry is going to be written many times, but later (e.g., after every wraparound). Hence, the conventional scheme used for data cache windows where the heat index is not incremented for regular data access for sequential I/O access does not work for journals since that would result in ensuring journal pages are not cached.

The conventional scheme used for data I/O (read or write) where once a real cache window is allocated, a cache-line is made valid by first reading the data from the corresponding LBAs on the storage medium and writing the same data to the corresponding cache device (a so-called cache read-fill operation) is not suitable for journals. This is because of the pure write-only nature of journal pages. Writes on journal pages are guaranteed to arrive sequentially, and hence the cache-line which is read from the storage medium as part of the cache read-fill operation will get overwritten by subsequent writes from the host. So, the cache read-fill operation during journal write is clearly unnecessary. Reads on a valid cache-line are of course fetched from the cache device. But, more importantly, a read operation on a cache-line that is invalid should be directly serviced from the storage medium, and the cache window and/or cache-lines should not be updated in any manner. This is because, for journals, reads are issued only during journal recovery time. The workload is write-only in nature. Hence, trying to do a cache read-fill on a read of data from the storage medium is highly detrimental to the performance of journal I/O.

In various embodiments, the above characteristics of journal pages containing file system meta-data are taken into account and a separate set of global tracking structures that are best suited for tracking journal pages are implemented. The same methods are applicable to the management of transaction logs for databases. The database transaction logs are managed in a way that is almost identical the file system journals. Thus, the features provided in accordance with embodiments of the invention for file system journals may also be applied to transaction logs for databases.

In various embodiments, a journal I/O is detected by trapping the I/O and checking whether the associated LBA corresponds to a journal entry. The determination of whether the associated LBA corresponds to a journal entry can be done using existing facilities and services available from conventional file system implementations and, therefore, would be known to those of ordinary skill in the field of the invention and need not be covered in any more detail here. Once a journal I/O is detected, the corresponding I/O is marked (or tagged) as a journal I/O using suitable “hint values” and passed to a caching layer. The mechanisms for marking the I/Os already exist and hence are not covered in any more detail here. The caching layer looks at the I/Os that are marked and determines, based on the corresponding hint values, whether the I/Os are journal I/Os.

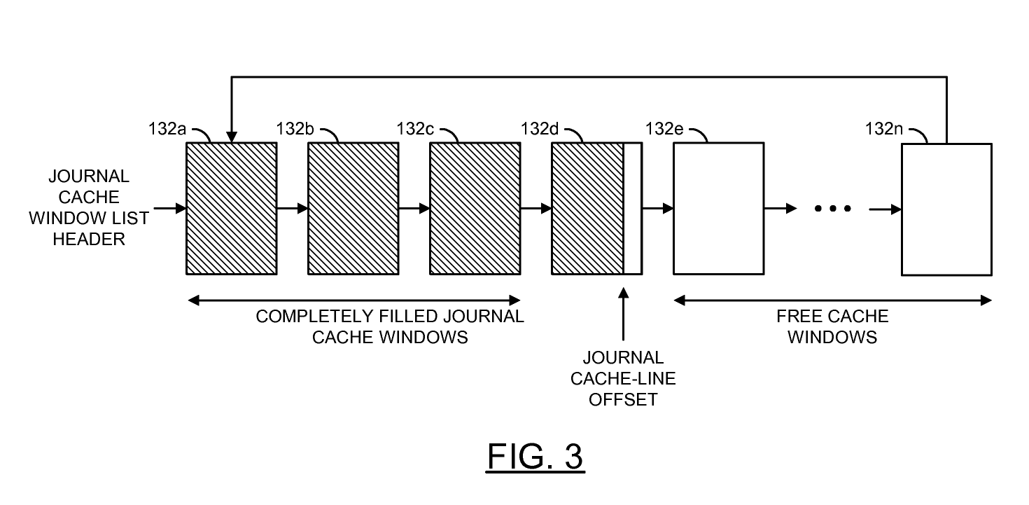

Referring to FIG. 3, a diagram is shown illustrating an example of journal cache-line offset tracking in accordance with an embodiment of the invention. For each cache device containing a file system, the last block of the last journal write, referred to as the journal cache-line offset, is tracked.

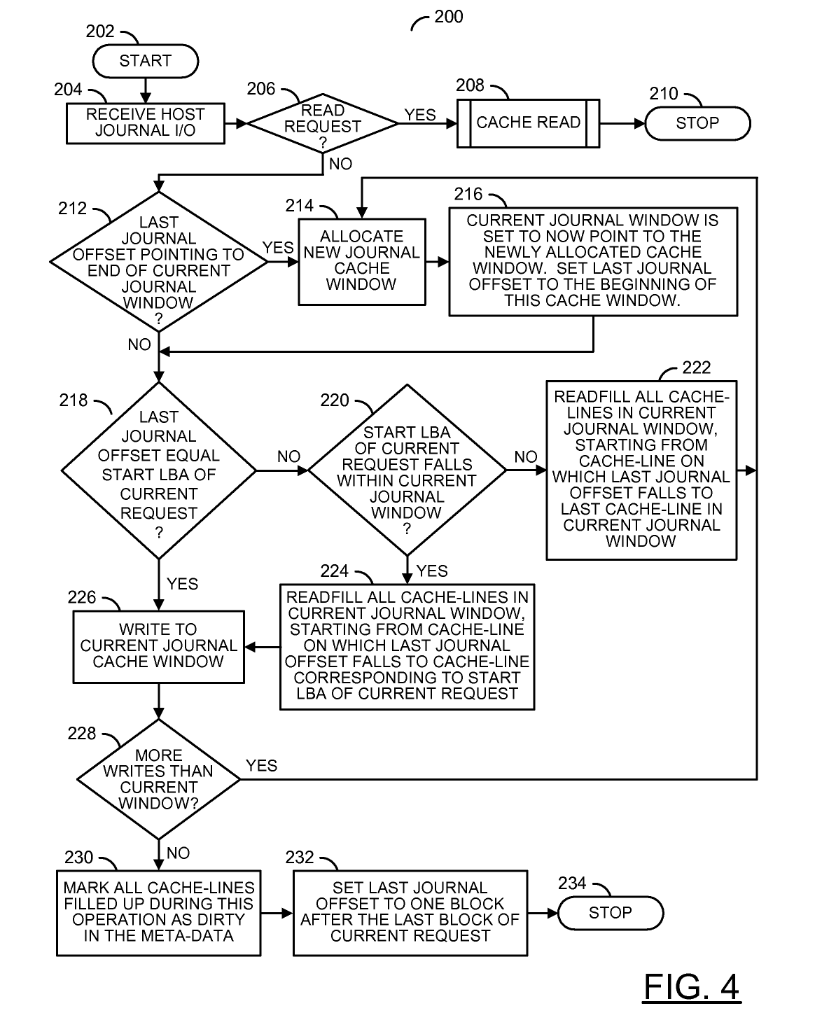

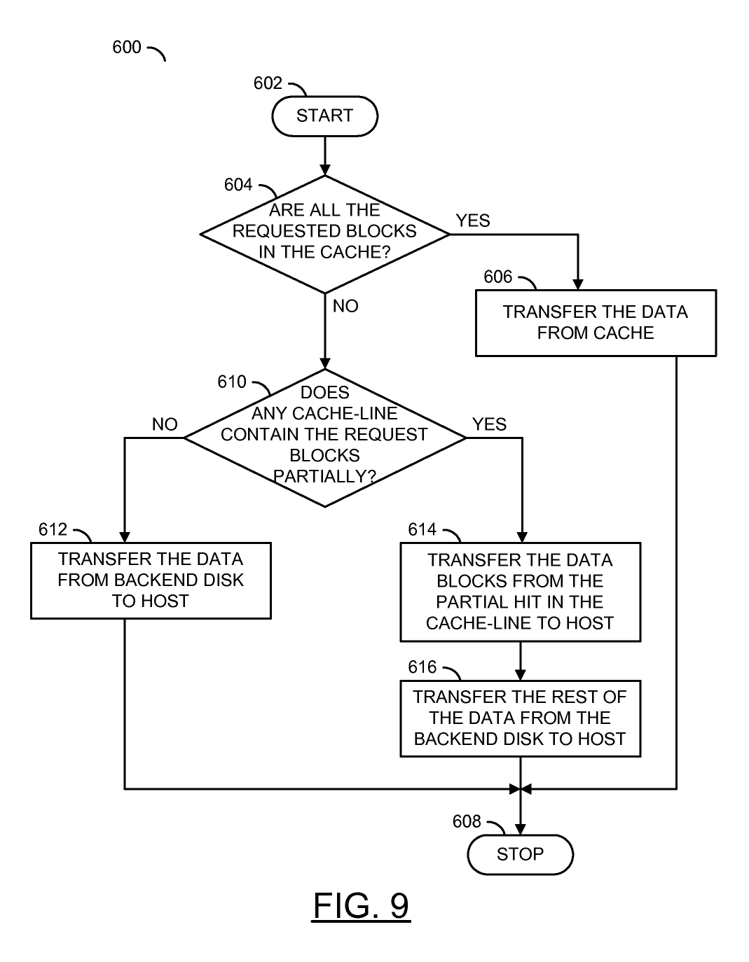

Referring to FIG. 4, a diagram illustrating a process 200 for journal cache management is shown. In various embodiments, the process (or method) 200 comprises a number of steps (or states) 202-234. The process 200 begins with a start step 202 and moves to a step 204. In the step 204, the process 200 receives a host journal I/O request. In a step 206, the process 200 determines whether the received host journal I/O request is a read request. When the host journal I/O request is a read request, the process 200 moves to a step 208 to perform a cache read operation (described below in connection with FIG. 9), then moves to a step 210 and terminates.

If in the step 206, the host journal I/O request is determined to be a write request, the process 200 moves to a step 212. In the step 212, the process 200 determines whether the last journal offset points to the end of the current journal window. If the last journal offset points to the end of the current journal window, the process 200 performs a step 214, a step 216, and a step 218. If the last journal offset does not point to the end of the current journal window, the process 200 moves directly to the step 218. In the step 214, a new journal window is allocated. In the step 216, the current journal window is set to point to the newly allocated cache window and the last journal offset is set to the beginning of the newly allocated cache window. In the step 218, the process 200 determines whether the last journal offset is equal to the start LBA of the current request.

In the step 218, the block number of the write request is compared with the journal cache-line offset. If the block number of the write request is not sequentially following the journal cache-line offset (e.g., the last journal offset is not equal to the start LBA of the current request), the process 200 moves to a step 220, followed by either a step 222 or steps 224 and 226. If the last journal offset is equal to the start LBA of the current request, the process 200 moves directly to the step 226. In the step 220, the process 200 determines whether the start LBA of the current request falls within the current journal window. If the start LBA of the current request does not fall within the current journal window, the process 200 moves to the step 222. If the start LBA of the current request falls within the current journal window, the process 200 performs the steps 224 and 226.

In the step 222, the process 200 readfills all the cache-lines in the current journal window, starting from the cache-line on which the last journal offset falls to the last cache-line in the current journal window, then moves to the step 214. In the step 224, the process 200 readfills all the cache-lines in the current journal window, starting from the cache-line on which the last journal offset falls to the cache-line corresponding to the start LBA of the current request, then moves to the step 226. In the step 226, the process 200 writes to the current journal cache window, then moves to a step 228. In the step 228, the process 200 determines whether there are more writes than the current window. When there are more writes than the current window, the process 200 moves to the step 214. When there are not more writes than the current window, the process 200 moves to a step 230. In the step 230, the process 200 marks all cache-lines filled up during the current operation as dirty in the meta-data, then moves to the step 232. In the step 232, the process 200 sets the last journal offset to one block after the last block of the current request. The process 200 the moves to the step 234 and terminates.

The allocation of cache windows can be done from a dedicated pool of cache windows for journal data as shown in FIG. 2. It is also possible that the cache windows are allocated from a global free pool of cache windows. When the block is sequentially following the journal cache-line offset, the write request is issued on the cache device on the blocks sequentially following the journal cache-line offset and possibly writing several consecutive cache-lines. The journal cache-line offset is updated to the last block number of the write request. The cache-lines that are now completely filled are marked dirty in the cache-line meta-data 136. Even if the journal cache-line offset does not end on a cache-line boundary, the cache-line containing the journal cache-line offset is still marked dirty as well. Both the journal cache-line offset and other cache meta-data are updated in the RAM 116 (if implemented) as well as on the cache device 104.

Whenever a cache window is to be flushed, the determination of which cache-lines to flush is based on picking all the valid cache-lines that are marked dirty. Using this scheme, the cache-line containing the journal cache-line offset may never get picked. This is because the cache-line containing the journal cache-line offset is still in the invalid state although the cache-line has been marked dirty. In conventional cache schemes, a read/write on invalid cache-lines is preceded by a cache read-fill operation to make the cache-lines valid. Hence, for a cache-line with an invalid state, the state of the dirty/clean flag has no meaning in the conventional schemes.

In various embodiments, an additional state is introduced. The additional state is referred to as a “partially valid” state. The partially valid state is implemented for each cache-line in a cache window, in addition to the valid and invalid states. In some embodiments, the state of the cache-line is set to “dirty” even if the cache-line is marked as invalid. The cache controller is configured to recognize the state of a cache-line marked both dirty and invalid as partially valid by correlating and ensuring that the journal cache-line offset falls on the particular cache-line. The latter approach is used as an example in the following explanation.

In various embodiments, because the writes to journal data do not involve prior read-fills, special processing is done for the cache-line containing the journal cache-line offset during cache flush scenarios. For example, a first processing step is performed to find out if the cache-line containing the journal cache-line offset is “partially valid” (e.g., both the “Dirty” and “Invalid” states are asserted). If so, a read-fill operation is performed for the “Invalid” portion of the cache-line from the storage medium, and then, the entire cache-line is written (flushed) to the storage medium as part of the steps that constitute a flush of a cache-line.

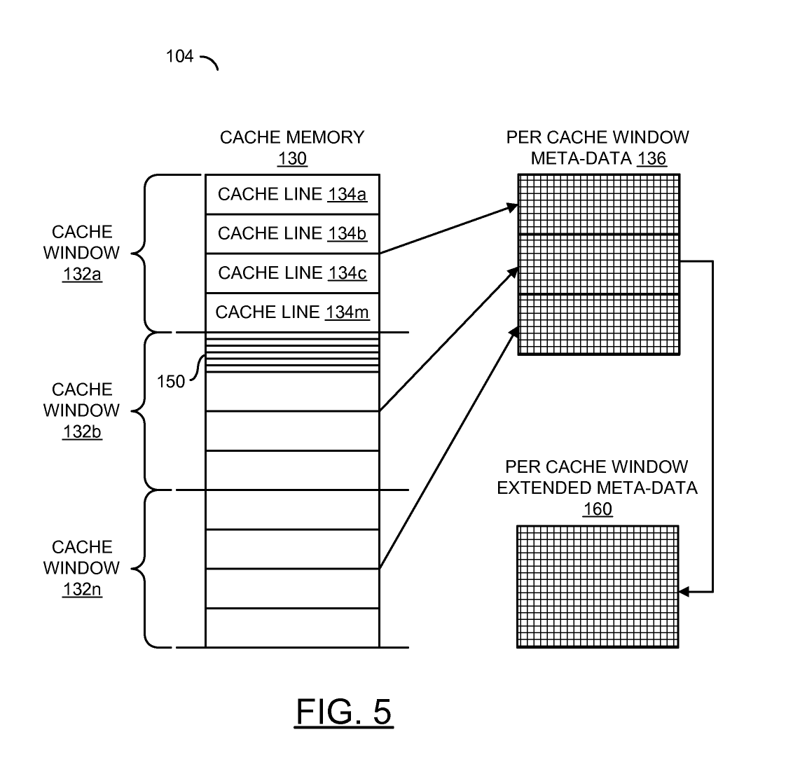

Referring to FIG. 5, a diagram is shown illustrating a sub-cache-line data structure in accordance with an embodiment of the invention. In some embodiments, for each cache device containing a file system, the cache-lines 134a-134m holding journal data are sub-divided into sub-cache-lines 150 on demand. The journal cache windows 132a-132n holding journal data can have data in both cache-line and sub-cache-line granularity. The sub-cache-lines 150 are tracked with extended meta-data 160 (e.g., one bit representing whether a corresponding sub-cache-line 150 is dirty).

Since the size of a sub-cache-line is necessarily smaller than the size of a cache-line 134a-134m, the size of the extended meta-data 160 per cache window is large. Therefore, only a limited number of the cache windows 132a-132n are allowed to have corresponding extended meta-data 160. In various embodiments, the pool of memory holding the limited set of extended meta-data 160 is pre-allocated. Regions containing the per cache window extended meta-data 160 are associated with the respective cache windows 132a-132n on demand and returned back to a free pool of extended meta-data 160 when all the sub-cache-lines 150 within one of the cache-lines 134a-134m are filled up with journal writes.

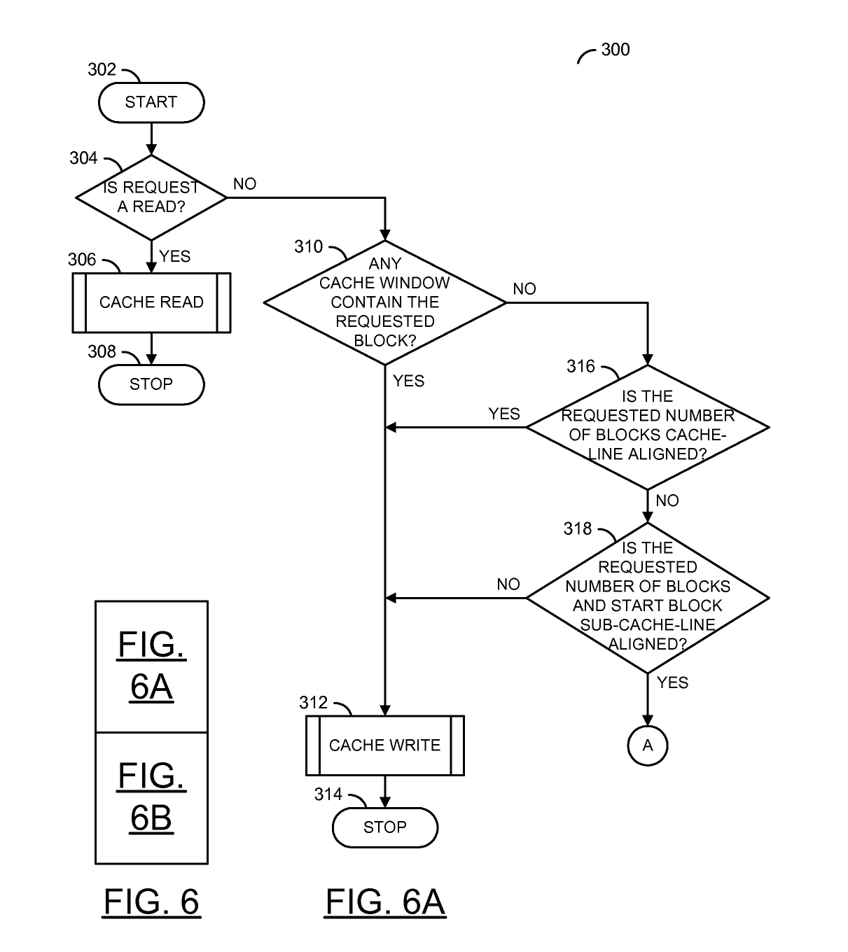

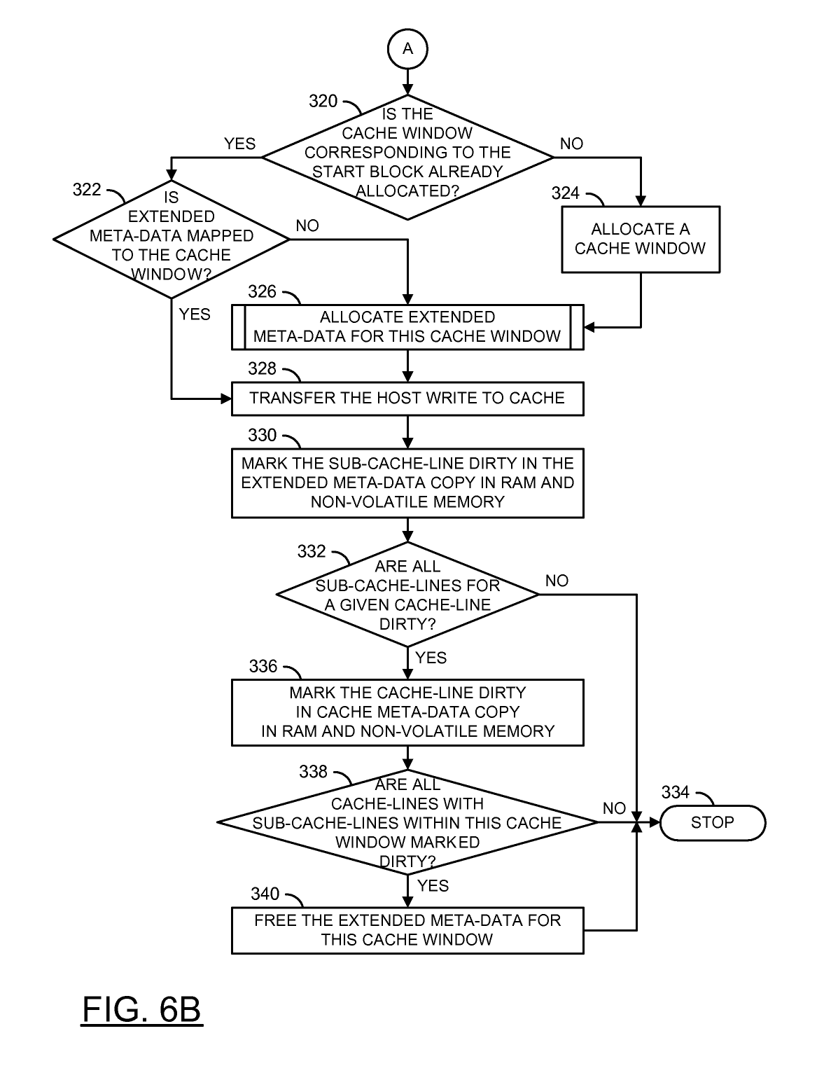

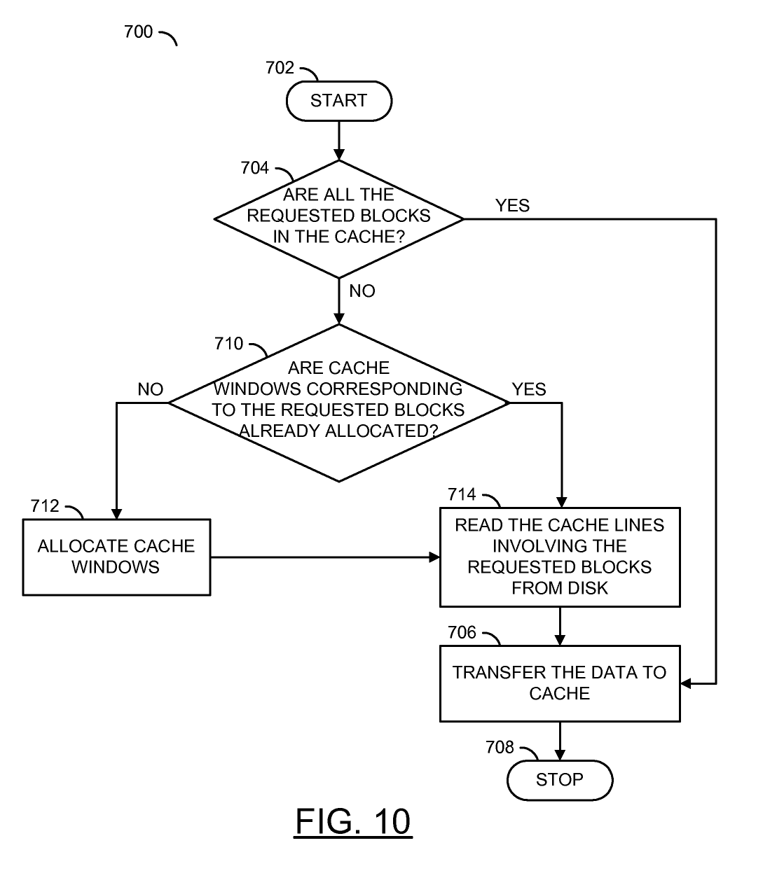

Referring to FIGS. 6A-6B, a diagram of a process 300 is shown illustrating a caching scheme for journal read or write requests. In various embodiments, the process 300 comprises a number of steps (or states) 302-340. The process (or method) 300 begins in the step 302 when a host journal request is received. The process 300 moves to a step 304 where a determination is made whether the journal request is a read or a write. If the journal request is a read, the process 300 moves to a step 306, where a cache read is performed (as described below in connection with FIG. 9). The process 300 then moves to a step 308 and terminates. If, in the step 304, the journal request is determined to be a write, the process 300 moves to a step 310 to determine whether any cache window contains the requested block. If a cache window contains the requested block, the process 300 moves to a step 312 to perform a cache write (as described below in connection with FIG. 10), followed by a step 314 where the process 300 is terminated.

If a cache window does not contain the requested block, the process 300 moves to a step 316 to determine whether the requested number of blocks are aligned with a cache-line boundary. If the number of blocks are cache-line aligned, the process proceeds to the steps 312 and 314. If the requested number of blocks are not cache-line aligned, the process 300 moves to a step 318 where a determination is made whether the requested number of blocks and a start block are aligned with a sub-cache-line boundary. If the requested number of blocks and the start block are not sub-cache-line aligned, the process 300 proceeds to the steps 312 and 314. Otherwise, the process 300 moves to a step 320.

In the step 320, the process 300 determines whether the cache window corresponding to the start block is already allocated. If the cache window is already allocated, the process 300 moves to a step 322. If the cache window is not already allocated, the process 300 moves to a step 324. In the step 322, the process 300 determines whether extended meta-data is mapped to the cache window. If extended meta-data is not mapped to the cache window, the process 300 moves to a step 326. If extended meta-data is already mapped to the cache window, the process 300 moves to a step 328. In the step 324, the process 300 allocates a cache window, then moves to the step 326.

In the step 326, the process 300 allocates extended meta-data to the cache window, then moves to the step 328. In the step 328, the host write is transferred to the cache and the process 300 moves to a step 330. In the step 330, the sub-cache-line is marked as dirty in the extended meta-data copy in RAM and on the cache device. The process 300 then moves to the step 332. In the step 332, the process 300 determines whether all sub-cache-lines for a given cache-line are dirty. If all sub-cache-lines for a given cache-line are not dirty, the process 300 moves to a step 334 and terminates. If all sub-cache-lines for a given cache-line are dirty, the process 300 moves to a step 336 to mark the cache-line dirty in the cache meta-data copy in RAM and on the cache device, then moves to a step 338.

In the step 338, the process 300 determines whether all cache-lines with sub-cache-lines within the cache window are marked as dirty. If all the cache-lines with sub-cache-lines within the cache window are not marked as dirty, the process 300 moves to the step 334 and terminates. If all the cache-lines with sub-cache-lines within the cache window are marked as dirty, the process 300 moves to the step 340, frees the extended meta-data for the cache window, then moves to the step 334 and terminates.

When a host journal write request is received, the block number of the request is used to search the cache. If data is already available in the cache (e.g., a cache-line HIT is found), then the cache-line is updated with the host data and the cache-line is marked as dirty. If (i) a cache-line HIT is not found, (ii) the cache window corresponding to the start block of the journal write request is already in the cache, and (iii) the write request size is not a multiple of the cache-line size, an extended meta-data structure 130 is allocated and mapped to the cache window (if not already allocated and mapped). The host write is then completed and the sub-cache-line bitmap is updated in the extended meta-data 130 in RAM and on the cache device. If the cache-line HIT is not found and a cache window corresponding to the journal write request is not already present, a cache window is allocated. If the journal write request size is not a multiple of the cache-line size, an extended meta-data structure 140 is allocated and mapped to the cache window, the host journal write is completed and the sub-cache-line bitmap is updated in the extended meta-data 140 in RAM and on the cache device.

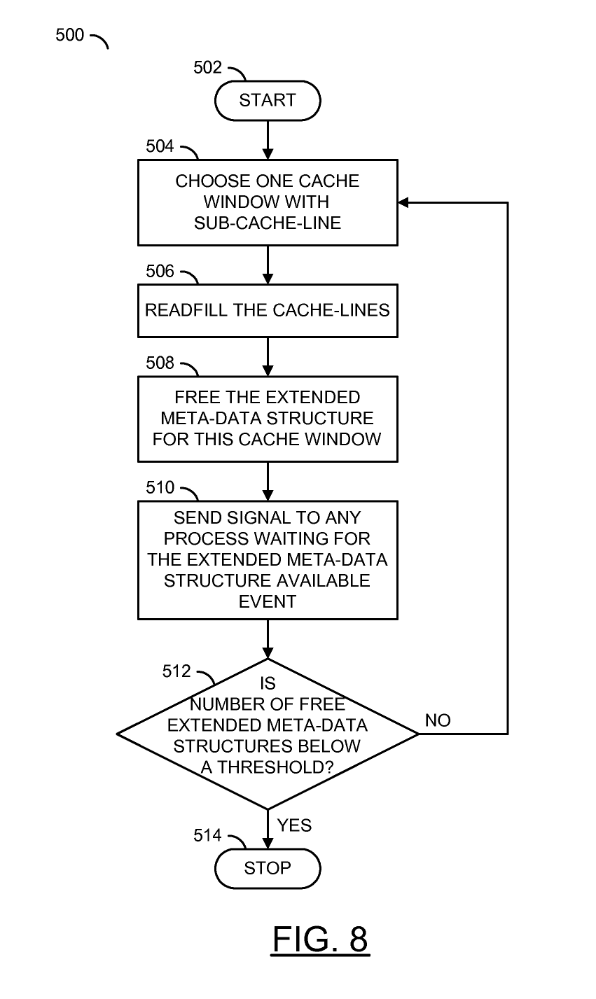

In various embodiments, once the number of cache windows with extended meta-data exceeds a predefined threshold (e.g., defined as some percentage of the number of cache windows reserved for journal I/O), a background read-fill process (described below in connection with FIG. 8) is started. The background read-fill process chooses a cache window (e.g., a cache window with maximum number of partially filled cache-lines) and the remaining data of the partially filled cache-lines are read from the storage medium (e.g., backend disk). After all the partially filled cache-lines of a cache window are filled, the cache-line dirty bitmap is updated in the meta-data 136 and the extended meta-data 140 for the cache window is freed up.

In some embodiments, a timer may be implemented for each partially filled cache window the first time extended meta-data 140 is allocated for the cache window. After the timer expires, the partially filled cache-lines of the cache window are read-filled and the extended meta-data 140 for the cache window is freed up.

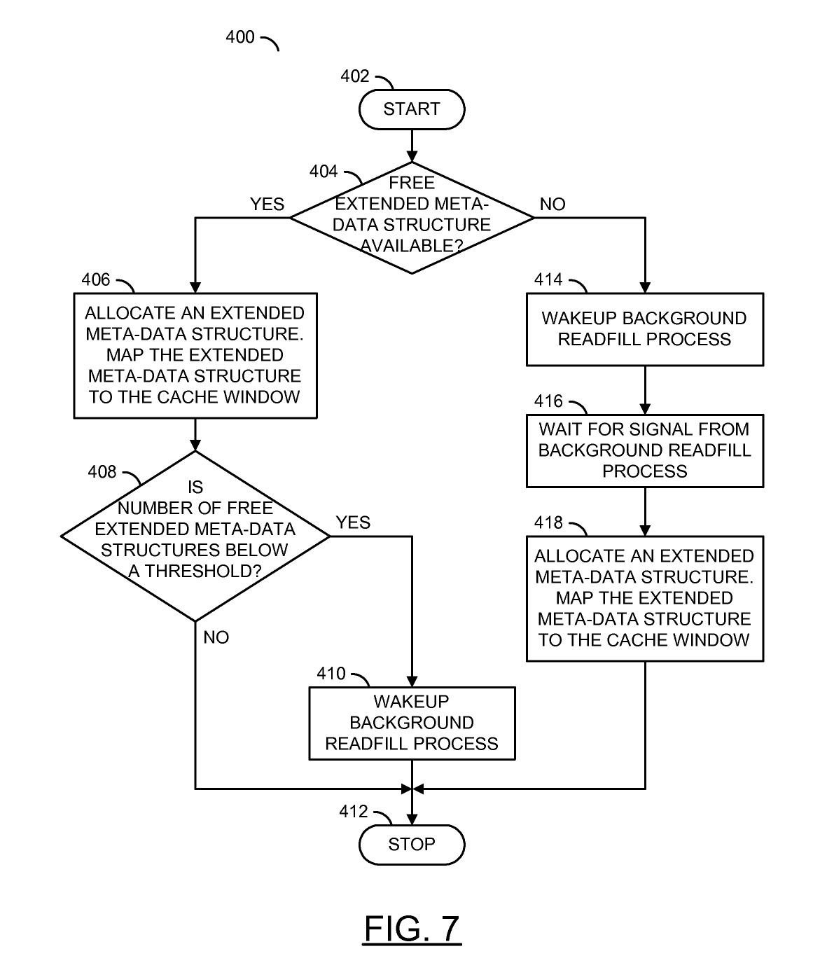

Referring to FIG. 7, a diagram of a process 400 is shown illustrating a procedure for allocating an extended meta-data structure in accordance with an embodiment of the present invention. The process (or method) 400 may comprise a number of steps (or states) 402-418. The process 400 begins in the step 402 and moves to a step 404. In the step 404, the process 400 determines whether free extended meta-data structures are available. If a free extended meta-data structure is available, the process 400 moves to a step 406. In the step 406, the process 400 allocates an extended meta-data structure and maps the extended metadata structure to the cache window. The process 400 then moves to a step 408. In the step 408, the process 400 determines whether the number of free extended meta-data structures is below a predetermined threshold. If the number of free extended meta-data structures is below the threshold, the process 400 moves to a step 410 where a background read-fill process (described below in connection with FIG. 8) is awakened. When the background read-fill process has been awakened in the step 410, or the number of free extended meta-data structures was determined to not be below the threshold in the step 408, the process 400 moves to a step 412 and terminates.

If, in the step 404, a free extended meta-data structure is not available, the process 400 moves to a step 414 and awakens the background read-fill process and moves to a step 416. In the step 416, the process 400 waits for a signal from the background read-fill process. Once the signal is received from the background read-fill process, the process 400 moves to a step 418 and allocates an extended meta-data structure. The extended meta-data structure is then mapped to the cache window and the process 400 moves to the step 412 and terminates.

It is possible that the number of available extended meta-data structures become exhausted. When the number of available extended meta-data structures is exhausted, a background read-fill process (described below in connection with FIG. 8) is triggered (awakened). The background read-fill process cleans up the partially filled cache-lines 134 and frees the associated extended meta-data 140. The scheme implemented in the sub-cache-line embodiments can also be applied generically to normal data write I/O when the I/O size is not a multiple of a cache-line size, but is sub-cache-line aligned.

Referring to FIG. 8, a diagram of a process 500 is shown illustrating an example read-fill procedure. In various embodiments, the process 500 has a number of steps (or states) 502-514. The process 500 begins in the step 502 and moves to a step 504. In the step 504, the process 500 chooses one cache window with a sub-cache-line and then moves to a step 506. In the step 506, the process 500 read-fills the cache-lines and moves to a step 508. In the step 508, the extended meta-data structure for the cache window is freed up and the process 500 moves to a step 510. In the step 510, a signal is sent to any process waiting for the extended meta-data structure to be available. In a step 512, the process 500 determines whether the number of free extended meta-data structures is below a predetermined threshold. If not, the process 500 returns to the step 504. If the number of free extended meta-data structures is below the threshold, the process 500 moves to the step 514 and terminates. Referring to FIG. 9, a diagram of a process 600 is shown illustrating an example cache read procedure. In various embodiments, the process 600 comprises a number of steps (or states) 602-616. The process 600 begins in a step 602 and moves to a step 604. In the step 604, a determination is made whether all the requested blocks are in the cache. If so, the process 600 moves to a step 606 where data is transferred from the cache, then moves to a step 608 where the process 600 terminates. If all the requested blocks are not in the cache, the process 600 moves to a step 610. In the step 610, the process 600 determines whether any cache-line contains all or part of the requested blocks. If not, the process 600 moves to a step 612 where the data is transferred from the storage medium to the host, then moves to the step 608 where the process 600 terminates. If the requested blocks are even partially contained in the cache-line, the process 600 moves to a step 614. In the step 614, the data blocks are transferred from the partial hit in the cache-line to the host 110, then the process 600 moves to a step 616. In the step 616, the rest of the data is transferred directly from the storage medium 106 to the host 110. The process 600 then moves to the step 608 and terminates.

In some embodiments, when the host issues a read request for the journal data and there is a cache HIT, the read request is served from the cache. If however, there is a MISS, the request is served from the storage medium (e.g., the backend disk) bypassing the cache device 112. If the read request is a partial HIT (e.g., the read is only partially available in cache device), the data in the cache device is read from cache device and the remaining data is retrieved from the storage medium as shown in FIG. 9. However, at no point does the data from the storage medium fill up the cache device during the read operation.

Referring to FIG. 10, a diagram of a process 700 is shown illustrating an example cache write procedure. In various embodiments, the process 700 comprises a number of steps (or states) 702-714. The process 700 begins in the step 702 and moves to a step 704. In the step 704, the process 700 determines whether all the requested blocks are in the cache. If all the requested blocks are in the cache, the process 700 moves to a step 706, where the data is transferred to the cache 104, then moves to a step 708, where the process 700 terminates. If, in the step 704, all the requested blocks are not in the cache, the process 700 moves to a step 710. In the step 710, a determination is made whether the cache windows corresponding to the requested blocks are already allocated. If the cache windows corresponding to the requested blocks are not already allocated, the process moves to a step 712. In the step 712, cache windows are allocated. If, in the step 710, the cache windows corresponding to the requested blocks are already allocated, the process 700 moves to the step 714, where the cache-line involving the requested blocks is read from the storage medium 106. After either the step 712 or the step 714 is completed, the process 700 moves to the step 706, where the data is transferred to the cache 104, then moves to the step 708, where the process 700 terminates.

When the host issues a write request that has a size that is either a multiple of a cache-line size or which is unaligned to a sub-cache-line boundary, a check is made to determine if the requested data blocks are already in a cache window. If not, then the requested blocks are read in from the storage medium as shown in FIG. 10. Then the requested blocks from host are written to the cache.

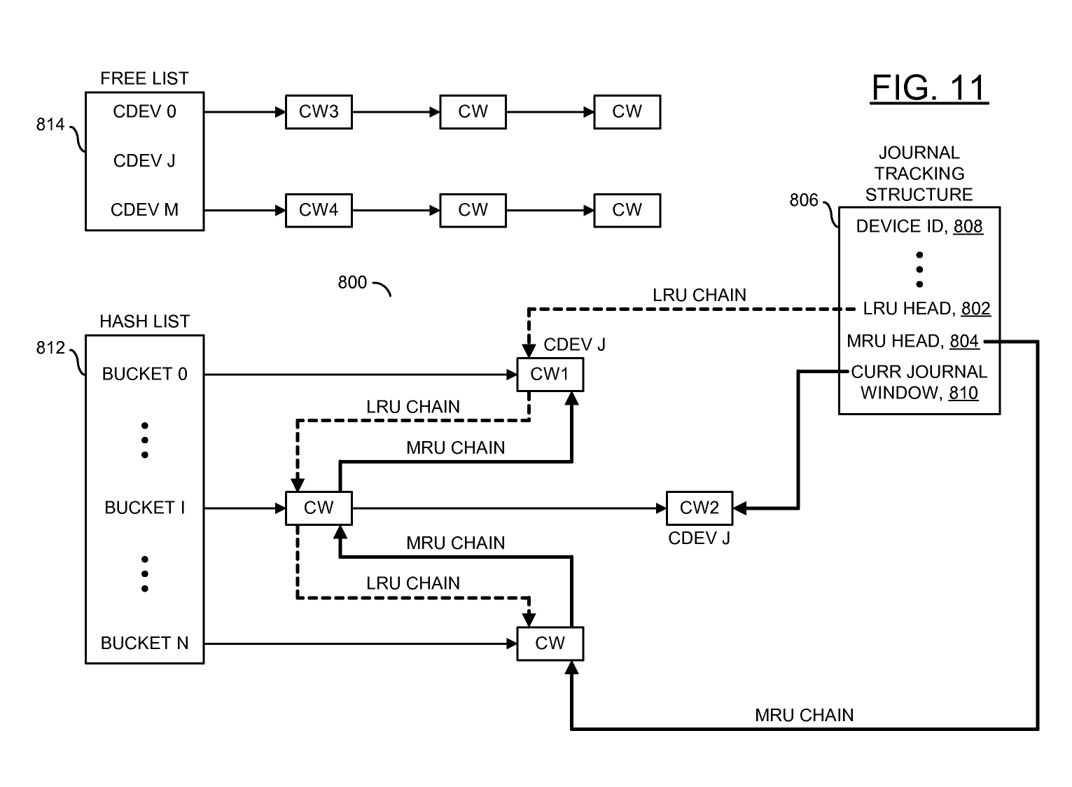

Referring to FIG. 11, a diagram is shown illustrating a doubly-linked list of a least recently used/most recently used (LRU/MRU) chain 800. In some embodiments, for each storage device 108a-108n, the cache windows for the journals are arranged in the form of a doubly-linked list resulting in the LRU/MRU chain 800. The beginning of the LRU list is pointed at by a LRU Head pointer 802. The beginning of the MRU list is pointed at by a MRU Head pointer 804. Whenever there is pressure to release cache windows, the candidate is chosen by walking through the MRU list starting from the location pointed to by the MRU Head pointer 804.

In various embodiments, for each of the storage devices 108a-108n containing a file system, a corresponding journal tracking structure 806 is identified by a device ID of the particular storage device (e.g., <Device ID>). The tracking structure 806 comprises fields for the following entries: Device ID 808, Cache Window size, Cache-Line size, Start LBA of the Journal area, End LBA of the Journal area, LRU Head pointer 802, MRU Head pointer 804, Current Journal Window pointer 810. For each storage device, the cache windows for the journals are arranged in the form of a doubly-linked list resulting in the LRU/MRU chain 800 pointed at by the LRU Head pointer 802 and MRU Head pointer 804, respectively (as shown in FIG. 11).

Linear searching for an entry starting from the location pointed at by the MRU Head pointer 804 can be expensive in terms of time in some of the configurations. In such cases where search efficiency is important, the entries can additionally be placed on a Hash list 812 where the hashing is done based on logical block addresses (e.g., <LBA Number>). The <LBA Number> corresponds to the <Start LBA> of the I/O request for which a search is made for a matching entry.

The Current Journal Window field 810 points to the most-recent journal entry that is being updated and is not full. Once this cache window is full (e.g., an update results in reaching the End LBA of the cache window pointed to by the Current Journal Window field 808), the cache window is inserted at the location pointed to by the MRU Head pointer 804 after setting the Current Journal Window field 808 to point to a newly allocated journal cache window.

In various embodiments, a separate free list 814 is maintained for journal I/Os. The free list 814 is used to control and provide an upper-bound on how many cache windows journal I/Os claim. Even among all the different journals, those that are meta-data intensive workloads should be allocated more journal cache windows. The free list 814 comes from the free list of (data) cache windows itself. However, managing a separate free list of journal cache windows gives more control on allocation and growing or shrinking the resources allocated to the journal cache windows. Another characteristic of the MRU entries is that each of the MRU entries are sorted in terms of the respective LBAs, and are arranged in decreasing order.

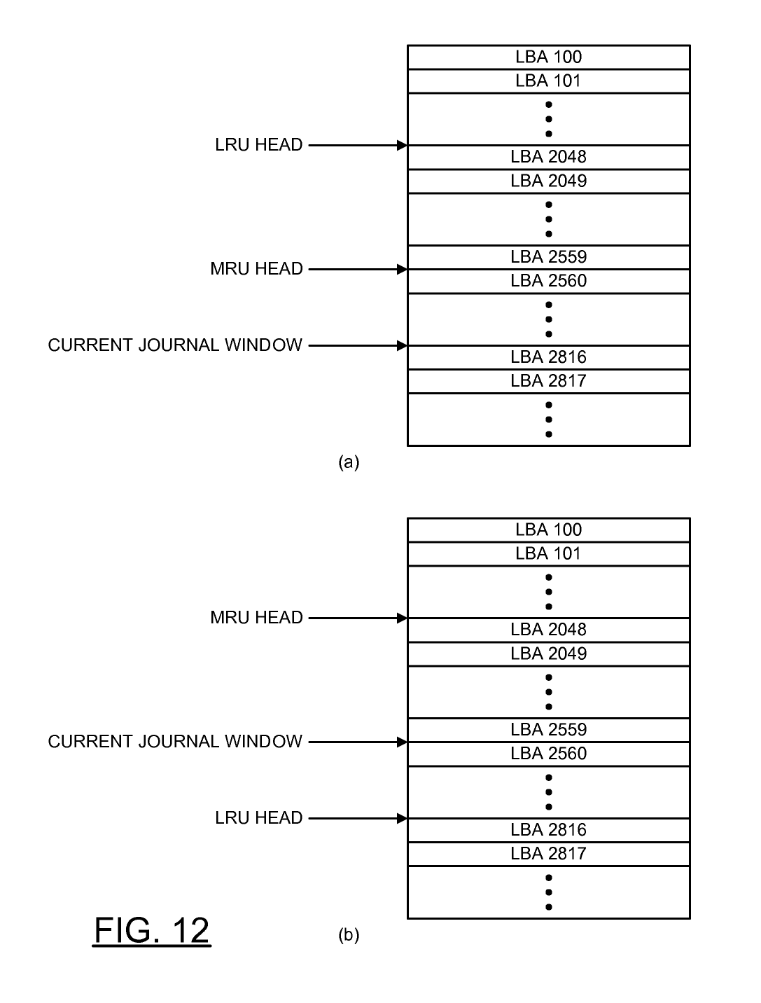

Since the journal is circular, the journal can wrap around (as shown in FIG. 12). Caching needs to recognize the circular nature of the journal when searching for a cached journal entry (described above in connection with FIGS. 3 and 4). The Current Journal Window 810 is maintained to point to the most recent journal cache window. The most recent journal cache window is the journal cache window on which journal writes are currently being performed and hence needs to be retained at all times. For this reason, the current journal window is excluded from MRU replacement. The exclusion of the current journal window from MRU replacement is ensured by pointing MRU Head 804 to the journal cache window that follows after the current journal window, and hence is the next most recent entry after the entry pointed to by the Current Journal Window field 810. MRU replacement handles this accordingly by operating on all entries starting from the MRU Head pointed to by the MRU Head pointer 804, going through the entries pointed by the MRU chain, and ending at the entry pointed to by the LRU Head pointer 802. Whenever there is pressure to release cache windows, the candidate is chosen by walking through the MRU list starting from the location pointed to by the MRU Head pointer 804, which of course excludes the cache window pointed at by the Current Journal Window field 810.

In various embodiments, once a file system is mounted from a storage device, the following steps are performed on the first journal write (e.g., when the first journal entry is written to a journal device): The journal tracking structure 806 is allocated; The Device ID field 808 is initialized to point to the journal device; The Cache Window size, Cache-Line size, Start LBA of the Journal area, and End LBA of the Journal area fields are initialized based on the file system. The LRU Head pointer 802 and MRU Head pointer 804 are empty; The Current Journal Window field 810 points to a newly allocated journal cache window (as described above in connection with FIG. 11).

At least one active journal cache window is implemented for each storage device 108a-108n once the file system on the respective storage device 108a-108n is mounted and the first journal entry has been written. The at least one active journal cache window is pointed at by the Current Journal Window field 810 in the journal tracking structure 806, as explained above. For each journal tracking structure 806, the following parameters are tracked: min_size (in LBAs)=8 (e.g., 4 KB); max_size (in LBAs)=total journal size; curr_size=the current size (in LBAS) allocated for journal. The amount of total free cache windows for journals can be based on some small percentage of total data space (e.g., 1%), and may be programmable.

The free list of journal cache windows 814 can be managed either as a local pool for each device or as a global pool across all devices. Implementing a local pool is trivial, but is sub-optimal: if the I/O workload does not generate journal I/O entries, the corresponding cache remains unused and is hence wasted. Implementing a global pool is complex, but makes optimal use of the corresponding cache windows. In addition, the global pool allows for over allocation based on demand from file systems that have high journal I/O workload. Later, when there is pressure on journal pages (e.g., no free cache windows in the free list 814), the over allocated journal cache windows can be freed back. Since such global pool management techniques are well known and conventionally available, no further description is necessary.

Searching if a journal page is cached may be implemented as illustrated by the following pseudo-code:

```
Let JCached Start LBA = Start LBA of Journal Cache Window
at LRU Head;
Let JCached End LBA = End LBA of Journal Cache Window at
MRU Head;
Let LBA searched = Start LBA corresponding to the Journal
I/O issued;
  Based on Device ID, locate the journal list for
  this device (key is <Device ID>)
  Check if LBA searched falls within “Current Journal
  Window”.
  If “in range”:
    Return Success
  Else { Not in “Current Journal Window” }:
    If LBA searched is in range <JCached Start
    LBA, JCached End LBA>, then:
      Scan through the LRU list
      If Journal Cache Window found containing
      LBA searched
        Return Success
  Return Failure
```

The read I/O requests on the journal are handled in the manner described above in connection with FIG. 9. The write I/O requests on the journal are handled in the manner described above in connection with FIG. 10.

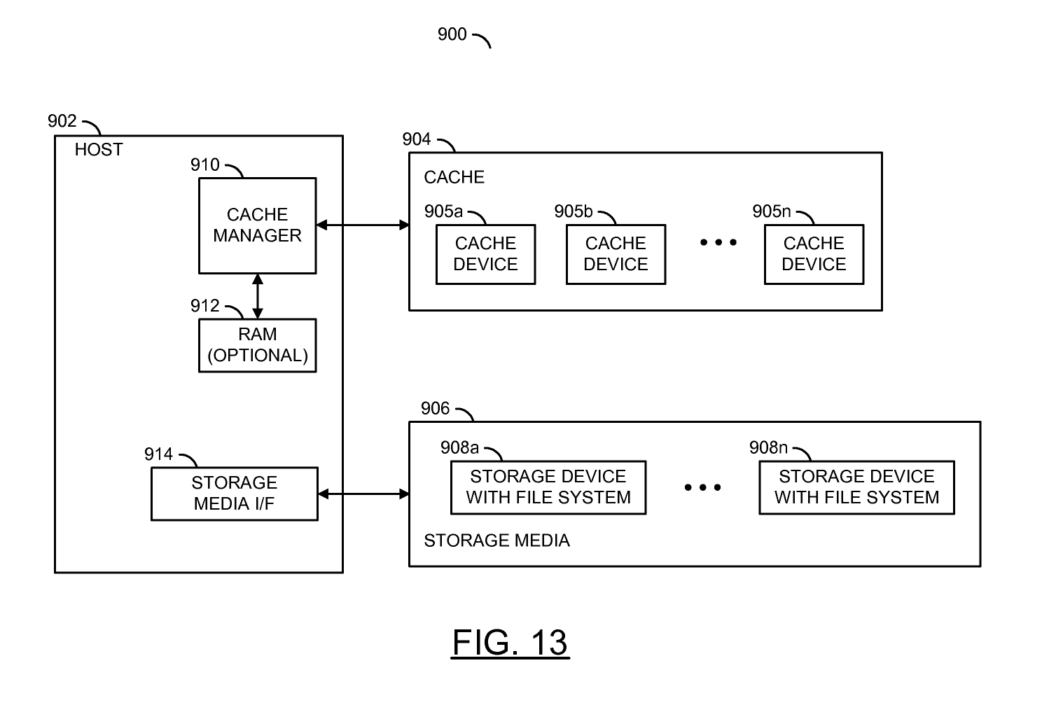

Referring to FIG. 13, a diagram of a system 900 is shown illustrating a storage system in accordance with another example embodiment of the invention. In general, the location of the cache manager implemented in accordance with embodiments of the invention is not critical. The cache manager can be either on a separate controller (as illustrated in FIG. 1) or on the host itself. In various embodiments, the system 900 comprises a block (or circuit) 902, a block (or circuit) 904, and a block (or circuit) 906. The block 902 implements a host system. The block 904 implements a cache. In various embodiments, the block 904 may be implemented as one or more cache devices 905a-905n. The one or more cache devices 905a-905n are generally administered as a single cache (e.g., by a cache manager 910 of the host 902). The block 906 implements a storage media (e.g., backend drive, virtual drive, etc.). The block 906 may be implemented using various technologies including, but not limited to magnetic (e.g., HDD) and Flash (e.g., NAND) memory. The block 906 may comprise one or more storage devices 908a-908n. Each of the one or more storage devices 908a-908n may include all or a portion of a file system.

In various embodiments, the host 902 comprises the cache manager 910, a block 912 and a block 914. The block 912 implements an optional random access memory (RAM) that may be configured to store images of cache management information (e.g., meta-data) in order to provide faster access. In some embodiments, the block 912 may be omitted. The block 914 implements a storage medium interface (I/F). The blocks 904, 910 and 912 (when present) generally implement journal caching data structures and schemes in accordance with embodiments of the invention.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The functions illustrated by the diagrams of FIGS. 1-13 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

While the invention has been particularly shown and described with reference to embodiments thereof, it will be understood by those skilled in the art that various changes in form and details may be made without departing from the scope of the invention.

1. An apparatus comprising:
a memory configured to implement a cache and store meta-data, said cache comprising one or more cache windows, each of said one or more cache windows comprising a plurality of cache-lines configured to store information, wherein each of said plurality of cache-lines is associated with meta-data indicating one or more of a dirty state, an invalid state, and a partially dirty state; and
a controller connected to said memory and configured to (i) detect an input/output (I/O) operation directed to a file system recovery log area, (ii) mark a corresponding I/O using a predefined hint value, and (iii) pass the corresponding I/O along with the predefined hint value to a caching layer.

2. The apparatus according to claim 1, wherein said I/O operation is directed to at least one of a file system journal entry and a database transaction log entry.

3. The apparatus according to claim 1, wherein said memory comprises one or more cache devices.

4. The apparatus according to claim 1, wherein said controller is configured to recognize a particular cache-line as being partially dirty based upon (i) the particular cache-line being marked as dirty and invalid, and (ii) a journal cache-line offset pointing within the particular cache-line.

5. The apparatus according to claim 1, wherein a journal cache window is allocated on a first ever write in the file system recovery log area corresponding to said journal cache window.

6. The apparatus according to claim 1, wherein if the I/O request is a write request to the file system recovery log area at a journal cache-line offset within a current journal cache window, no cache fill operation is performed for the non-dirty portion of the journal cache-line before performing a cache write of the current journal cache window.

7. The apparatus according to claim 1, wherein in a cache flush scenario, if there is a partially dirty cache-line, the non-dirty portion of the cache-line is filled from a storage medium communicatively coupled to said controller before flushing the cache-line.

8. The apparatus according to claim 1, wherein a read request on entries in the file system recovery log area is served from the cache if the entries are already in the cache, and the portions that are not in the cache are directly served from a storage medium communicatively coupled to said controller without filling the cache.

9. The apparatus according to claim 1, wherein journal cache windows are organized and searched either as a list of entries in a fixed priority index in a common hash list of cache windows or as a separate hash list constructed for entries in the file system recover log area.

10. The apparatus according to claim 1, wherein a most recently used (MRU) replacement scheme is used to replace journal cache windows when no free journal cache windows are available for allocation.

11. The apparatus according to claim 1, wherein a current journal cache window is maintained and excluded from being replaced in any cache window replacement scheme.

12. The apparatus according to claim 1, wherein said controller is configured to detect wraparound in connection with writes to the file system recovery log area.

13. The apparatus according to claim 1, wherein at least one of said plurality of cache-lines associated with a journal cache window is further divided into a plurality of sub-cache-lines.

14. The apparatus according to claim 13, wherein said memory is further configured to store extended meta-data indicating whether any of said sub-cache-lines are dirty.

15. The apparatus according to claim 14, wherein an amount of said extended meta-data is pre-allocated.

16. The apparatus according to claim 14, wherein the extended meta-data is dynamically associated with said journal cache window.

17. The apparatus according to claim 14, wherein the extended meta-data associated with said journal cache window is released once all the sub-cache-lines in the corresponding cache-lines of said journal cache window are marked dirty.

18. The apparatus according to claim 14, wherein the cache-lines are filled in a background task when an amount of extended meta-data stored crosses a threshold.

19. A method of managing a cache comprising:
storing information in at least one of a plurality of cache-lines of a cache window, wherein each of said plurality of cache-lines is associated with meta-data indicating one or more of a dirty state, an invalid state, and a partially dirty state;
detecting an input/output (I/O) operation directed to a file system recovery log area;
marking a corresponding I/O using a predefined hint value; and
passing the corresponding I/O along with the predefined hint value to a caching layer.

20. The method according to claim 19, wherein said I/O operation is directed to at least one of a file system journal entry and a database transaction log entry.
